(19) United States
(12) Patent Application Publication
(10) Pub. No.: US 2016/0073246 A1
(43) Pub. Date: Mar. 10, 2016

(54) SYSTEM AND METHOD FOR SETTING AND SWITCHING PARTIES FOR PAYMENT OF TELEPHONE CALLS

(71) Applicants: Fu Tai Hua Industry (Shenzhen) Co., Ltd., Shenzhen (CN); HON HAI PRECISION INDUSTRY CO., LTD., New Taipei (TW)

(72) Inventor: YU TAN, Shenzhen (CN)

(21) Appl. No.: 14/573,757

(22) Filed: Dec. 17, 2014

(30) Foreign Application Priority Data
Sep. 9, 2014 (CN) 201410456429.1

(51) Int. Cl. H04W 4/24

(52) U.S. Cl. CPC H04W 4/24

(57) ABSTRACT

A method for setting and switching a party responsible for payment of a remainder of a telephone call made between a first mobile device and a second mobile device can include receiving and saving information of a first mobile device, determining whether a switching condition for switching the party responsible for payment of the remainder of the telephone call is met during the telephone call, and switching the party responsible for payment of the remainder of the telephone call from the first mobile device to the second mobile device when the switching condition is met. The second mobile device is one of a number of contact mobile devices of the first mobile device. Phone numbers of the contact mobile devices are included in the information of the first mobile device.

### FIELD

The subject matter herein generally relates to telephone technologies, and more particularly to a system and method for switching parties responsible for payment of a telephone call.

### BACKGROUND

Generally, when a mobile device that initiates a telephone call with another mobile device, the initiating mobile device is responsible for payment of the telephone call.

### BRIEF DESCRIPTION OF THE DRAWINGS

Implementations of the present technology will now be described, by way of example only, with reference to the attached figures.

FIG. 1 is a block diagram of an embodiment of a system for setting and switching parties responsible for payment of a remainder of a telephone call.

FIG. 2 is a flowchart of an embodiment of a method for setting and switching parties responsible for payment of a remainder of a telephone call.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

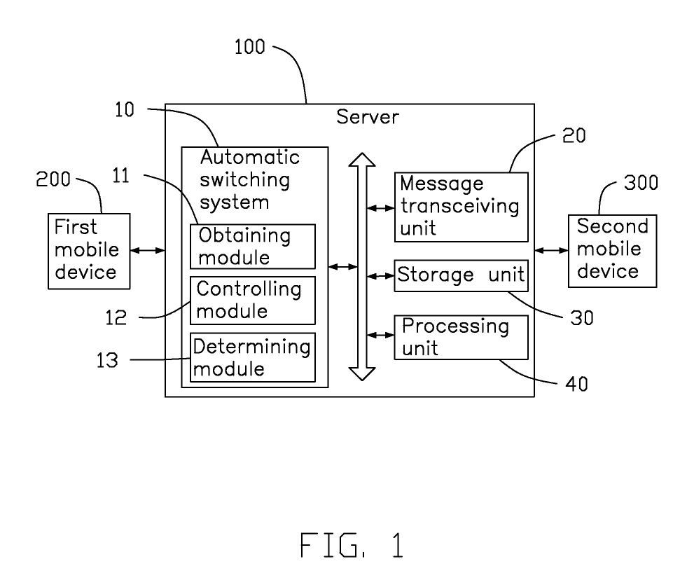

FIG. 1 illustrates an exemplary embodiment of a system for setting and switching parties responsible for payment of a remainder of a telephone call. The system can include a server 100, a first mobile device 200, and a second mobile device 300. The telephone call can be made between the first mobile device 200 and the second mobile device 300. The second mobile device 300 may be one of a plurality of contact mobile devices (not shown) of the first mobile device 200. The first mobile device 200 can be responsible for payment of the telephone call.

The server 100 can include an automatic switching system 10 for switching the party responsible for payment of the remainder of the telephone call from the first mobile device 200 to the second mobile device 300. The server 100 can further include a message transceiving unit 20, a storage unit 30, and a processing unit 40. The message transceiving unit 20 can send and receive a plurality of messages to and from the first mobile device 200 and the plurality of contact mobile devices. The automatic switching system 10 may include a plurality of modules, such as an obtaining module 11, a controlling module 12, and a determining module 13. The modules 11-13 may include one or more software programs in the form of computerized codes stored in the storage unit 30. The computerized codes can include instructions executed by the processing unit 40 to provide functions for the modules 11-13.

The obtaining unit 11 can obtain information sent by the first mobile device 200. The information can include a switching condition for switching the party responsible for payment of the remainder of the telephone call, and phone numbers of the plurality of contact mobile devices. The switching condition can be a charge amount of the first mobile device 200 being below a predetermined amount. In at least one embodiment, the predetermined amount can be set by a user of the first mobile device 200.

The controlling unit 12 can control the message transceiving unit 20 to send a first message to the plurality of contact mobile devices according to the phone numbers in the information sent by the first mobile device 200. The first message can request each of the contact mobile devices to accept to be switched to become the party responsible for payment of a remainder of telephone calls made with the first mobile device 200 when the switching condition is met.

Each of the contact mobile devices can send a second message to the message transceiving unit 20. The second message can inform the server 100 whether the corresponding contact mobile device 300 accepts or rejects the request.

After receiving the second message, the controlling unit 12 can control the message transceiving unit 20 to send a third message to the first mobile device 200 and each of the contact mobile devices that accept the request. Each third message can inform the first mobile device 200 and the corresponding contact mobile device that the corresponding contact mobile device has accepted the request to be switched to become the party responsible for paying for a remainder of telephone calls made with the first mobile device when the switching condition is met.

The determining unit 12 can determine whether the switching condition is met during the telephone call between the first mobile device 200 and the second mobile device 300. When the determining unit 12 determines that the switching condition is met, the controlling unit 12 can switch the party responsible for payment of the remainder of the telephone call from the first mobile device 200 to the second mobile device 300.

After the party responsible for payment of the remainder of the telephone call is switched from the firs mobile device 200 to the second mobile device 300, the controlling unit 12 can control the message transceiving unit 20 to send a fourth message to the first mobile device 200 and the second mobile device 300. The fourth message can inform the first mobile device 200 and the second mobile device 300 that the party responsible for paying for the remainder of the telephone call has been switched from the first mobile device 200 to the second mobile device 300.

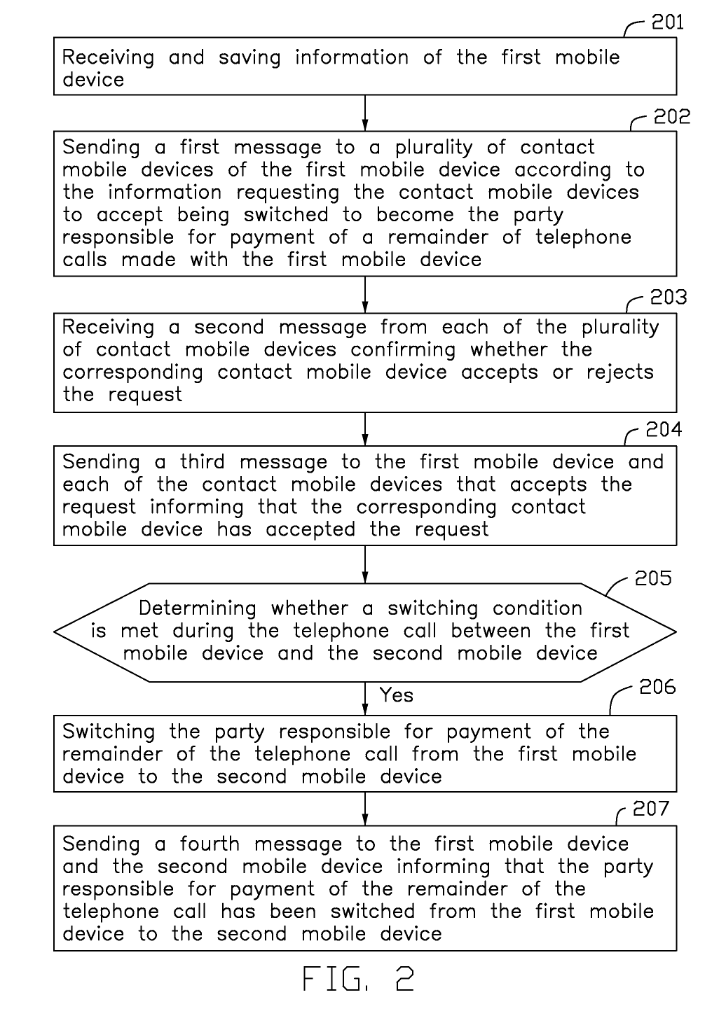

FIG. 2 illustrates a flowchart of a method for setting and switching parties responsible for payment of a remainder of a telephone call from a first mobile device to a second mobile device. The example method is provided by way of example, as there are a variety of ways to carry out the method. The method described below can be carried out using the configurations illustrated in FIG. 1, for example, and various elements of the figure are referenced in explaining the example method. Each block shown in FIG. 2 represents one or more processes, methods, or subroutines carried out in the example method. Furthermore, the illustrated order of blocks is by example only, and the order of the blocks can be changed. Additional blocks may be added or fewer blocks may be utilized, without departing from this disclosure. The example method can begin at block 201.

At block 201, information of the first mobile device is received and saved. The first mobile device can be responsible for payment of the telephone call. The information can include a switching condition and phone numbers of a plurality of contact mobile devices. The second mobile device is one of the plurality of contact mobile devices. The switching condition is a condition for switching the party responsible for payment of the remainder of the telephone call from the first mobile device to the second mobile device. The switching condition can be a charge amount of the first mobile device being lower than a predetermined amount.

At block 202, a first message can be sent to the plurality of contact mobile devices. The first message can request each of the plurality of contact mobile devices to accept to be switched to become the party responsible for payment of a remainder of telephone calls made with the first mobile device when the switching condition is met.

At block 203, a second message can be received from each of the plurality of contact mobile devices. Each second message can inform whether the corresponding contact mobile device accepts or rejects the request to be switched to become the party responsible for payment of a remainder of telephone calls made with the first mobile device when the switching condition is met.

At block 204, a third message can be sent to the first mobile device and each of the contact mobile devices that accepts the request. Each third message can inform the first mobile device and the corresponding contact mobile device that the corresponding contact mobile device has accepted the request to be switched to become the party responsible for paying for a remainder of telephone calls made with the first mobile device when the switching condition is met.

At block 205, whether the switching condition is met during the telephone call between the first mobile device and the second mobile device can be determined. If the switching condition is met, block 206 is implemented. If the switching condition is not met, block 205 is repeated.

At block 206, the party responsible for payment of the remainder of the telephone call can be switched from the first mobile device to the second mobile device.

At block 207, a fourth message can be sent to the first mobile device and the second mobile device after the party responsible for paying for the remainder of the telephone call is switched from the first mobile device to the second mobile device. The fourth message can inform the first mobile device and the second mobile device that the party responsible for payment of the remainder of the telephone call has been switched from the first mobile device to the second mobile device.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method for switching parties responsible for payment of a telephone call, the method comprising:
receiving and saving information of a first mobile device, the first mobile device being responsible for payment of the telephone call, and the information comprising a switching condition and phone numbers of a plurality of contact mobile devices;
determining whether the switching condition is met during the telephone call; and
switching a party responsible for payment of a remainder of the telephone call when the switching condition is met;
wherein the telephone call is made between the first mobile device and a second mobile device, the second mobile device being one of the plurality of contact mobile devices to which the telephone call is made; and
wherein the party responsible for payment of the remainder of the telephone call is switched from the first mobile device to the second mobile device.

2. The method as in claim 1 further comprising:
after receiving and saving the information of the first mobile device, sending a first message to the plurality of contact mobile devices, the first message requesting each of the plurality of contact mobile devices to accept to be switched to become the party responsible for payment of a remainder of telephone calls made with the first mobile device when the switching condition is met;
receiving a second message from each of the plurality of contact mobile devices, each second message informing whether the corresponding contact mobile device accepts or rejects the request to be switched to become the party responsible for payment of a remainder of telephone calls made with the first mobile device when the switching condition is met;
sending a third message to the first mobile device and each of the contact mobile devices that accept the request, each third message informing the first mobile device and the corresponding contact mobile device that the corresponding contact mobile device has accepted to be switched to become the party responsible for paying for a remainder of telephone calls made with the first mobile device when the switching condition is met; and
sending a fourth message to the first mobile device and the second mobile device after the party responsible for paying for the remainder of the telephone call is switched from the first mobile device to the second mobile device, the fourth message informing the first mobile device and the second mobile device that the party responsible for payment of the remainder of the telephone call has been switched from the first mobile device to the second mobile device.

3. The method as in claim 1, wherein the switching condition is a phone charge amount of the first telephone being less than a predetermined amount.

4. The method as in claim 3, wherein the predetermined amount is set by a user of the first mobile device.

5. A system for switching parties responsible for payment of a telephone call, the system comprising:
a first mobile device, the first mobile device being responsible for payment of the telephone call;
a second mobile device, the second mobile device being one of a plurality of contact mobile devices to which the telephone call is made;
a message transceiving unit configured to send and receive a plurality of messages to and from the first mobile device and the plurality of contact mobile devices;
a storage unit configured to store a plurality of instructions of a plurality of modules of an automatic switching system; and
a processing unit configured to execute the plurality of instructions of the plurality of modules of the automatic switching system, the plurality of modules comprising:
an obtaining module configured to obtain information sent by the first mobile device to the server;
a controlling module configured to control the message transceiving unit to send the plurality of messages to the first mobile device and the plurality of contact mobile devices, and further configured to switch the party responsible for payment of a remainder of the telephone call from the first mobile device to the second mobile device; and
a determining module configured to determine whether to switch the party responsible for payment of the remainder of the telephone call from the first mobile device to the second mobile device.

6. The system as in claim 5, wherein the message transceiving unit, the storage unit, the processing unit, and the automatic switching system are part of a server.

7. The system as in claim 5, wherein the information sent by the first mobile device is stored in the storage unit.

8. The system as in claim 5, wherein the information sent by the first mobile device comprises:
a switching condition for switching the party responsible for payment of the remainder of the telephone call from the first mobile device to the second mobile device; and
phone numbers of the plurality of contact mobile devices.

9. The system as in claim 8, wherein the plurality of messages sent and received by the message transceiving unit comprises:
a first message sent to the plurality of contact mobile devices according to the phone numbers in the information sent by the first mobile device, the first message requesting each of the plurality of contact mobile devices to accept to be switched to become the party responsible for payment of a remainder of telephone calls made with the first mobile device when the switching condition is met;
a second message received from each of the plurality of contact mobile devices, each second message informing whether the corresponding contact mobile device accepts or rejects the request to be switched to become the party responsible for payment of a remainder of telephone calls made with the first mobile device when the switching condition is met;
a third message sent to the first mobile device and each of the contact mobile devices that accept the request, each third message informing the first mobile device and the corresponding contact mobile device that the corresponding contact mobile device has accepted the request to be switched to become the party responsible for paying for a remainder of telephone calls made with the first mobile device when the switching condition is met; and
a fourth message sent to the first mobile device and the second mobile device after the party responsible for paying for the remainder of the telephone call is switched from the first mobile device to the second mobile device, the fourth message informing the first mobile device and the second mobile device that the party responsible for payment of the remainder of the telephone call has been switched from the first mobile device to the second mobile device.

10. The system as in claim 8, wherein the phone numbers of the contact mobile devices that accept the request are saved in the storage unit.

11. The system as in claim 8, wherein the switching condition is a charge amount of the first mobile device being lower than a predetermined amount.

12. The system as in claim 11, wherein the predetermined amount is set by a user of the first mobile device.

13. The system as in claim 11, wherein the determining module determines to switch the party responsible for paying for the remainder of the telephone call when the charge amount of the first mobile device is lower than the predetermined amount.
